(19) United States
(12) Patent Application Publication
(10) Pub. No.: US 2023/0015254 A1
(43) Pub. Date: Jan. 19, 2023

(54) POLYMERIC COMPOUND, CARTRIDGE, DEVICE AND METHOD FOR CAPTURING NI(II) IONS

(71) Applicants: INSTITUT POLYTECHNIQUE DE GRENOBLE, Grenoble (FR); CENTRE NATIONAL DE LA RECHERCHE SCIENTIFIQUE, Paris (FR); UNIVERSITE GRENOBLE ALPES, Saint Martin D'Heres (FR)

(72) Inventors: Jean-Claude LEPRETRE, Voreppe (FR); Jonathan DESEURE, Challes Les Eaux (FR); Fannie ALLOIN, Vizille (FR); Clémence YVER, Grenoble (FR)

(21) Appl. No.: 17/782,024

(22) PCT Filed: Dec. 3, 2020
(86) PCT No.: PCT/EP2020/084439

§ 371 Date: Jun. 2, 2022

(30) Foreign Application Priority Data
Dec. 3, 2019 (FR) 1913653

(51) Int. Cl. B01J 39/07; C08F 12/08; B01J 39/19; B01J 47/024; B01J 47/08; B01D 15/36; C25D 3/22

(52) U.S. Cl. CPC B01J 39/07; B01D 15/362; B01J 39/19; B01J 47/08; B01J 47/024; C08F 12/08; C25D 3/22; C08F 2810/00

(57) ABSTRACT

The disclosure relates to the field of metal ion capture, more particularly of selective capture of nickel Ni(II) ions, by a polymeric compound based on a polymer selected from styrenic polymers and chloropolymers. In the polymeric compound, at least one portion of the monomer units of the polymer is functionalised by the ligand, the ligand including at least one chemical group selected from the glyoxime groups.

The glyoxime groups have a strong affinity for the Ni(II) ions, as well as an excellent selectivity vis-à-vis metal ions of chemical properties similar to Ni(II) ions. This ligand thus allows a selective complexation of the Ni(II) ions by the polymeric compound, including in solutions of low concentrations of Ni(II) ions.

The polymeric compound according to at least one embodiment of the disclosure is particularly intended for capturing the Ni(II) ions during the electrogalvanising methods as well as for recycling material comprising nickel.

### TECHNICAL FIELD OF THE INVENTION

The invention relates to the field of metal ion capture, more particularly of selective capture of nickel Ni(II) ions.

### STATE OF THE ART

In electrochemical methods, it is common to use materials comprising nickel, for example, in stainless steel tanks, because these materials have a longer service life. During these electrochemical treatment methods, nickel can however be transformed into nickel Ni(II) ions, which can disrupt the operation of the methods and have a harmful impact on the environment.

This is the case in electrogalvanising methods, an easy-to-use and economically competitive method aimed at carrying out an electrochemical deposition of zinc on a material. The zinc deposition gives the material an essential resistance to corrosion in many applications, for example for sheet metals intended for the automobile or household appliances, screws, or for everyday goods such as shopping carts.

In the presence of a small amount of Ni(II) ions in the electrolyte bath, after a certain duration of zinc deposition, it is observed that the deposited zinc is dissolved, although the deposition current is maintained. This period before the dissolution is called “induction time” or “induction period”. This induction period is followed by a significant drop in the faradic efficiency then the dissolution of the deposited zinc. Thus, this prevents the proper operation of the electrogalvanising method and creates inhomogeneities (or equivalently pitting) on the zinc deposition.

In order to guarantee the proper operation of these electrochemical methods, it is therefore necessary to renew the electrolysis bath as soon as the concentration of Ni(II) ions becomes too significant. This concentration is however very low (from one to two tens of mg/L). Frequent renewals of the electrolysis bath are therefore performed, increasing the amount of effluents to be treated downstream of the method.

In order to limit the frequency of renewal of electrolysis baths, lead electrodes have traditionally been used. During electrogalvanising, these lead electrodes gradually disintegrate in the electrolysis bath and absorb traces of contaminating ions, and in particular traces of Ni(II) ions. This method allows lengthening the induction period and reducing the bath renewal frequency. However, the electrolysis bath, which should always be renewed and treated, includes lead and zinc, which are chemically difficult to separate and harmful to the environment.

In order to minimise the environmental impact of the method, these lead electrodes tend today to be replaced by high performance catalytic electrodes comprising noble metals, for example titanium electrodes coated with mixed metal oxide compositions comprising different elements such as iridium, ruthenium, platinum, rhodium and tantalum. However, the component elements of these electrodes do not ensure capturing Ni(II) ions. Another strategy is therefore used to delay the induction period. It consists of using surfactants or inhibitors of the hydrogen production reaction such as potassium sulphate. When the Ni(II) concentration becomes too significant, in particular as soon as it exceeds one to two tens of mg/L, it is however still necessary to renew the electrolysis bath.

Moreover, the nickel element has a high toxicity. In France, the limit value for average occupational exposure over 8 hours of nickel and the inorganic derivatives thereof is 1 mg/m³, with the exception of that of nickel sulphate, which is 0.1 mg/m³.

Furthermore, the Ni(II) ions have chemical properties which are very similar to other metal ions, and in particular cobalt Co(II) ions. Thus, it is very difficult to capture them selectively from each other in electrolysis baths and in the effluents from electrochemical methods, in particular in order to be able to valorise them.

The document Biswas et al., Synthesis and Some Properties of PVC-Bound Dimethylglyoxime Complexes of Co(11), Ni(11) and Cu(11), Journal of Applied PolymerScience, vol. 38, 1989, pages 1243-1252, describes a polymeric compound for the chelation of metal ions, obtained by reaction between the polyvinyl chloride and the dimethylglyoxime to form complexes with the Co(II), Ni(II) and Cu(II) ions. However, the complexation properties of this polymeric compound remain improvable.

An object of the present invention is therefore to propose a material aimed at selectively capturing traces of Ni(II) ions in solution. More particularly, an object of the invention aims, by the selective capture of traces of Ni(II) ions, at guaranteeing the proper operation of electrochemical methods such as electrogalvanisation. Furthermore, an object of the invention is to be able to selectively capture these traces of Ni(II) ions relative to other metal ions. Moreover, an object of the present invention aims at limiting the environmental impact of Ni(II) ions in solution.

The other objects, features and advantages of this invention will appear on examining the following description and the appended drawings. It is understood that other advantages can be incorporated.

### SUMMARY OF THE INVENTION

In order to achieve this objective, according to a first aspect, the present invention provides a polymeric compound based on a polymer selected from styrenic polymers and chloropolymers, characterised in that the polymer comprises monomer units capable of being functionalised by a ligand, at least one portion of said monomer units of the polymer being functionalised by the ligand. This ligand comprises at least one chemical group selected from the glyoxime groups of semi-structural formula HON═CRCR'═NOH, where R and R' are independently selected from a covalent bond between two carbon atoms, H, CH3, an alkyl group, and an alkylene group.

The glyoxime groups have a strong affinity for metal ions, and in particular the Ni(II) ions. These groups can further have a good selectivity relative to metal ions of chemical properties which are very similar to Ni(II) ions, and in particular relative to the cobalt Co(II) ions. This ligand thus allows a complexation of metal ions, and in particular Ni(II) ions by the polymeric compound, including in solutions of low concentrations of Ni(II) ions. The polymeric compound can allow a selective capture of the Ni(II) ions, in the state of traces as well as at more significant concentrations. The Ni(II) ions being captured by the polymeric compound, their impact on the operation of electrochemical method, as well as their environmental impact, are limited, even deleted.

The glyoxime group having the semi-structural formula above, the glyoxime group is attached to the monomer unit by at least one of R and R'. This attachment of the glyoxime group optimises the complexation of the metal ions by the glyoxime group. In particular, this allows forming between the glyoxime group and the metal ion a complex which is less sterically constrained relative to one attachment by another group or atom, for example the oxygen atom. Furthermore, the oxygen and nitrogen atoms are not directly connected to the metal ion, their participation in the complexation of metal ions is not reduced. The structure and functionality of the glyoxime group, for the complexation of metal ions, are thus preserved. The complexation of metal ions, and in particular Ni(II) ions, is therefore facilitated relative to the existing solutions, which improves their selective capture.

Optionally, the invention can further have at least one of the following features, used in combination or alternately.

The chemical group can be a methylglyoxime group of semi-structural formula HON═CRCR"═NOH, where R" represents CH3. Thus, the ligand can comprise at least one methylglyoxime group, even a plurality of methylglyoxime groups, in which methyl has in particular an inductive donor effect benefiting the capture of metal ions. The methylglyoxime groups have a particularly strong affinity for the Ni(II) ions, as well as an excellent selectivity relative to metal ions of chemical properties which are very similar to the Ni(II) ions, and in particular relative to the cobalt Co(II) ions.

The average molecular weight of the polymer free of the ligand can be comprised between 2000 and 10000 g/mol. The use of a polymer of low molecular weight, relative to the molecular weights of commercial polymers which are generally available, has several advantages. First, it is easier to obtain a high functionalisation rate of the monomer units of the polymer. Secondly, the ligands are thus more accessible for the capture of Ni(II) ions, or even ions of other metals, improving the capture efficiency by the polymeric compound. Preferably, the average molecular weight of the polymer free of the ligand is comprised between 2000 and 5000 g/mol.

Furthermore, the functionalisation rate by the ligand of the at least one portion of the monomer units of the, can be greater than 80%. The high functionalisation rate of the monomer units of the polymer allows increasing the amount of the ligand capable of capturing the Ni(II) ions, or even the ions of other metals. Moreover, in the case where more than one ligand is desirable for the complexation of an Ni(II) ion, a high functionalisation rate can increase the probability of having ligands close enough to form a complex with a Ni(II) ion, and thus increase the selectivity of the polymer. A high functionalisation rate can therefore allow facilitating the capture of Ni(II) ions and increase the ability of capturing Ni(II) ions by the polymeric compound.

The monomer units capable of being functionalised by the ligand can be units selected from styrene units and the derivatives thereof, vinyl chloride units and 4-chloromethyl-styrene units. The polymeric compound according to this feature has several advantages. First, the polymeric compound can be neutral, even insoluble in a solution such as an electrolysis bath or an effluent from an electrochemical method, and in particular in an aqueous medium. The polymeric compound can then form a solid phase which can be easily isolated from the solution. For example, the polymeric compound is recoverable by filtration. Secondly, the polymeric compound can be resistant to the operating conditions of electrochemical treatments, thus improving its duration of use during these treatments.

The at least one portion of the polymer monomer units functionalised by the ligand can correspond to one of the following formulas (I), (II) and (III)—

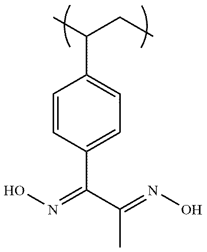

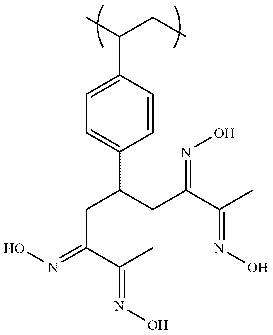

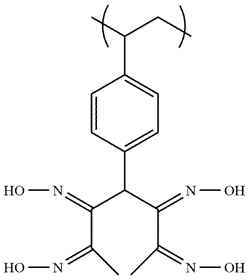

A second aspect of the present invention concerns a cartridge configured to contain the polymeric compound, in which at least one wall comprises openings configured so as to allow a fluid to circulate on either side of said at least one wall, while maintaining the polymeric compound inside the cartridge. The cartridge can thus be placed in a solution, such as an electrolysis bath or an effluent from an electrochemical method, so as to capture the Ni(II) ions in solution. When the polymeric compound reaches its limit ability of capturing Ni(II) ions, the cartridge can be easily removed from the bath without requiring a filtration of the solution, and replaced by another cartridge.

A third aspect of the present invention relates to a device for capturing Ni(II) ions in solution comprising the polymeric compound and a clean tank and intended to contain a solution, said solution being likely to comprise Ni(II) ions. Thanks to the capture of Ni(II) ions by the polymeric compound, the materials implemented during electrochemical treatments, such as by electrogalvanisation, can comprise a higher nickel content, consequently increasing the service life of these materials. The device may in particular comprise stainless steel materials, comprising nickel. The service life of the device is thus increased, and its cost reduced.

The polymeric compound may further be contained in a cartridge, at least one wall of said cartridge comprising openings configured so as to allow the solution to circulate on either side of said at least one wall, while maintaining the polymeric compound inside the cartridge.

A fourth aspect of the present invention relates to a method for capturing Ni(II) ions in solution comprising the following steps:
providing, in a tank, a solution likely to comprise Ni(II) ions;
providing, in the tank, the polymeric compound.

The solution may be an effluent comprising Ni(II) ions, for example resulting from an electrochemical treatment method, or a solution capable of implementing an electrochemical treatment during which Ni(II) ions can be released, for example from the tank. Since the Ni(II) ions are captured by the polymeric compound, including at low concentrations of Ni(II) ions, the environmental impact of the solution can be limited or even eliminated.

In the step of providing the polymeric compound, the polymeric compound can be contained in at least one cartridge, at least one wall of said cartridge comprising openings configured so as to allow the solution to circulate on either side of said at least one wall, while maintaining the polymeric compound inside the cartridge.

The method may further comprise a step of at least partially immersing a material in the solution, and a step of treating by electrogalvanisation the immersed portion of the material, said solution comprising chemical species capable of implementing the treatment by electrogalvanisation. During the electrochemical treatment, the Ni(II) ions which can be released in solution can thus be captured by the polymeric compound. Capturing the Ni(II) ions can ensure the proper operation of the treatment by electrogalvanisation. More particularly, this capture allows limiting, or even eliminating, the phenomenon of induction.

The method may comprise a step of at least partially immersing a material in the solution, the material possibly comprising metal components based on nickel, or even based on a mixture of metals comprising nickel,, and a step for dissolving at least one portion of the metal components of the material. When metal components are dissolved, Ni(II) ions, or even a plurality of metal ions including Ni(II) ions, can be released in solution. The Ni(II) ions can thus be selectively captured by the polymeric compound, for example for the valorisation thereof and/or for the valorisation of the metal ions not captured by the polymeric compound. More particularly, metal ions with chemical properties which are very similar to Ni(II) ions, such as Co(II) ions, can thus be separated from Ni(II) ions.

### BRIEF DESCRIPTION OF FIGURES

The aims, objects, as well as the features and advantages of the invention will emerge better from the detailed description of one embodiment thereof which is illustrated by the following accompanying drawings in which:

FIG. 1A represents a perspective view of a cartridge comprising the polymeric compound, according to one embodiment of the invention.

FIG. 1B represents a perspective view of a cartridge, according to another embodiment of the invention.

FIG. 2 represents a sectional view of a device for capturing Ni(II) ions according to one embodiment of the invention.

FIG. 3 represents a sectional view of a device according to another embodiment of the invention as that illustrated in FIG. 2.

FIG. 4 represents a sectional view of a device according to another embodiment of the invention as those illustrated in FIGS. 2 and 3.

FIG. 5 schematically represents the steps of the method for capturing Ni(II) ions according to one embodiment of the invention.

The drawings are given by way of examples and are not limiting to the invention. They constitute schematic representations of principle intended to facilitate understanding of the invention and are not necessarily scaled to practical applications. In particular, the relative dimensions of the elements comprised in the device according to one aspect of the invention are not representative of reality.

### DETAILED DESCRIPTION OF THE INVENTION

It is specified that within the scope of the present invention, the term “styrenic polymer” designates a family of polymers derived from the styrene monomer or one of the derivatives thereof. This family of polymers comprises polystyrene homopolymer, sodium poly(styrene sulfonate), polymers derived from halogenated styrene derivatives, such as poly(chloromethylstyrene) for example, and the styrenic copolymers, where the styrene monomer, or the one of the derivatives thereof, is copolymerised with other monomers.

The term “chloropolymer” designates a family of polymers derived from alkene monomers in which at least one of the hydrogen atoms has been replaced by chlorine. This family comprises copolymers where these alkene monomers are copolymerised with other monomers, or even other alkene monomers in which at least one of the hydrogen atoms has been replaced by chlorine.

The term “monomer unit”, means a repeating molecular structure in a polymer, formed from a monomer. The polymers formed from a single monomer unit are called homopolymers. It comes to a copolymer when at least two monomer units, of different molecular structures, constitute the polymer.

Within the scope of the present invention, the word “ligand” corresponds to a molecular structure bearing chemical functions allowing it to bind to one or several atoms or ions.

The term “compound or material based on a material A” means a compound or material comprising, or being formed from, this material A, and optionally comprising other materials.

The term “solution likely to comprise a species A”, it is meant that the solution initially comprises the species A or that the species A can be released in solution, for example during the implementation of a method. Equivalently, the solution can be “intended to comprise” the species A.

Within the scope of the present invention, the polymer average molecular weights are given by weight.

### 1) Description of Particular Embodiments of the Polymeric Compound

The polymeric compound according to a first aspect of the invention comprises a polymer, at least one portion of the monomer units of the polymer being capable of being functionalised by a Ni(II) ion-selective ligand.

The Ni(II) ion-selective ligand comprises at least one chemical group chosen from the glyoxime groups. Glyoxime groups can be described by their semi-structural formula HON═CRCR'═NOH. In this formula, R and R' are independently selected from a covalent bond between two carbon atoms, H, CH₃, an alkyl group, and an alkylene group. An alkylene group is a carbon chain comprising at least one unsaturation. The alkyl and alkylene groups preferably comprise 1 to 4 carbon atoms, in order to limit the molecular weight of the ligand. These alkyl and alkylene groups may further comprise a cycle and/or be branched or unbranched.

Glyoxime groups have a strong affinity for Ni(II) ions. This high affinity allows capturing in particular Ni(II) ions in solution, and this, for a low concentration of Ni(II) ions. Glyoxime groups can further have an excellent selectivity for Ni(II) ions relative to other metal ions. This selectivity for Ni(II) ions can further be obtained for metal ions with chemical properties close to Ni(II) ions, such as cobalt Co(II) ions.

Preferably, the Ni(II) ion-selective ligand comprises at least one methylglyoxime group of semi-structural formula HON=CRCR"=NOH, where R" represents CH₃. Dimethylglyoxime is used in analytical chemistry to quantitatively detect Ni(II) ions. This detection is based on the formation of a quadri-coordinated bis(dimethylglyoximate) complex of nickel II, illustrated by the chemical reaction below. This group is consequently particularly advantageous for the selective capture of traces of Ni(II) ions. It should be noted that the formation of a square planar complex as described by the chemical reaction below is also valid for glyoxime groups in general, of semi-structural formula HON=CRCR'=NOH as previously described.

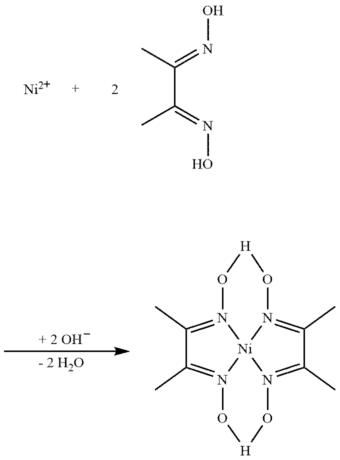

The bis(dimethylglyoximate) complex of nickel II thus formed is insoluble in aqueous solution. However, its recovery in solution requires a filtration at very low filtration dimensions, or an evaporation of the aqueous solution. The recovery of this complex may consequently not appear to be the best adapted to large-scale chemical methods, such as effluent treatment or industrial electrochemical methods. Furthermore, the operating conditions implemented during these methods may not be compatible with the formation of the bis(dimethylglyoximate) complex of nickel II in solution, as described by the reaction above.

In order to selectively capture the Ni(II) ions in solution, and this, in a manner compatible with a large-scale chemical method, the Ni(II) ion-selective ligand, as previously described, functionalises at least a part of the monomer units of a polymer to form the polymeric compound according to the invention. The Ni(II) ions can thus be complexed in the polymeric compound by the ligand. The polymeric compound, larger in size than an organometallic complex such as bis(dimethylglyoximate) complex of nickel II, is more easily recoverable, in particular by simple filtration. Following the capture of Ni(II) ions in solution by the polymeric compound, the Ni(II) ions can therefore be removed from a solution. The polymeric compound for capturing Ni(II) ions is therefore suitable for large-scale chemical methods, such as the effluent treatment or the industrial electrochemical methods.

The polymer is configured such that the monomer units are capable of being functionalised by the ligand. For this, the monomer units of the polymer can comprise an unsaturation, for example for a functionalisation by electrophilic substitution, or a halogenated heteroatom, preferably a chlorine atom. Preferably, the monomer units of the polymer comprise an aromatic ring.

The polymer is selected in particular from styrenic polymers and chloropolymers. The monomer units capable of being functionalised by the ligand can preferably be selected from styrene, chloromethylstyrene and vinyl chloride. Thus, the polymeric compound can be neutral, even insoluble in a solution such as an electrolysis bath or an effluent from an electrochemical method. In particular, the polymeric compound may be insoluble in an aqueous solution. The polymeric compound can therefore form a solid phase which can be easily isolated from the solution. More particularly, the polymeric compound can be in the form of strands or of powder. Furthermore, since the polymeric compound is insoluble, the polymeric compound can be resistant to the operating conditions of chemical methods, and in particular electrochemical methods. The risk of degradation of the polymeric compound, during the implementation of these methods, is consequently reduced, or even avoided.

Among the styrenic polymers and the chloropolymers, the polymer can be a copolymer, and for example a block copolymer. The use of a copolymer can allow changing the mechanical properties of the polymeric compound. More particularly, the glass transition temperature of the polymeric compound can be changed. For example and without limitation, mention may be made of styrene-butadiene or the poly(styrene-b-butadiene-b-styrene) block copolymer. The monomer units capable of being functionalised by the ligand can represent more than 50%, even more than 70%, even more than 80%, even more than 90% by weight of the polymer free of the ligand. According to one preferred embodiment of the polymeric compound, the polymer is a homopolymer. Moreover, the polymeric compound can be based on a crosslinked polymer. The crosslinking of the polymer can in particular allow reducing its solubility.

Preferably, the polymer may comprise a number of monomer units comprised between 15 and 200, more particularly between 15 and 80. The molecular weight of the polymer free of the ligand may be comprised between 2000 and 20000 g/mol, more particularly between 2000 and 10000 g/mol, and even more particularly between 1000 and 5000 g/mol. A low range in number of monomer units, or similarly, a low molecular weight of the ligand-free polymer, relative to the values usually found for the commercial polymers, allow increasing the accessibility of selective ligands for Ni(II) in solution. Thus, the capture of Ni(II) ions by the polymeric compound can be improved. The functionalisation of the monomer units by the ligand can further be facilitated. A high functionalisation rate of the monomer units by the ligand can thus be obtained, an aspect describes in more detail below.

For example, the polymeric compound can be based on a polystyrene homopolymer obtained by radical polymerisation, rather than a commercial polystyrene. The radical polymerisation allows adjusting the length of the polymer chains, and obtaining a polystyrene with a lower molecular weight than commercial polystyrenes, whose molecular weight is generally greater than 35000 g/mol.

The ligand functionalisation rate on at least one portion of the monomer units capable of being functionalised, is preferably greater than 80%. A high ligand functionalisation rate allows increasing the amount of ligand capable of capturing the Ni(II) ions, or even other metal ions. Thus, the ability of capturing the Ni(II) ions of the polymeric compound is increased. Consequently, the limit ability of capturing Ni(II) ions is extended. Thus, a large volume of solution can be treated by the polymeric compound. The capture of Ni(II) ions by the polymeric compound can be all the more suitable for large-scale chemical methods, such as the effluent treatment or the industrial electrochemical methods.

Furthermore, according to the previously illustrated chemical reaction, an Ni(II) ion can be complexed by two glyoxime groups. When the ligand comprises a single glyoxime group, it is therefore preferable that the ligands are sufficiently close in the polymeric compound. A high functionalisation rate allows increasing the likelihood of having ligands which are close enough to complex the Ni(II) ions. Furthermore, a possible reorganisation of the polymeric compound during the complexation of Ni(II) ions can be limited by the proximity of ligands, and thus increase the affinity of the polymeric compound for Ni(II) ions. This stronger affinity can thus allow capturing Ni(II) ions in solutions at even lower concentrations of Ni(II) ions.

Alternatively, the ligand can comprise at least two glyoxime groups. The glyoxime groups can thus be close enough to complex an Ni(II) ion within the same ligand. The possible reorganisation of the polymeric compound is thus minimised, which further increases the affinity of the polymeric compound for the Ni(II) ions. The glyoxime groups, as a reminder of a semi-structural formula HON= CRCR'=NOH, can be bonded to each other, for example via R and R', at least one of the R and R’ being preferably selected from CH₃, an alkyl group, and an alkylene group. Furthermore, the glyoxime groups, bonded to each other, preferably functionalise the monomer unit by a single covalent bond, for example as illustrated by the formulas (II) and (III) below, or a single alkyl or alkylene group, the number of carbon of which can be comprised between 1 and 4.

It is considered that the distance between the ligand and the polymer has little, if not, of influence on the affinity of the ligand for the Ni(II) ions. For the feasibility of the synthesis and overall synthesis efficiency, a group having a reduced number of carbon, even a single covalent bond, is nevertheless preferred to bind the glyoxime group(s) and the monomer unit.

According to a preferred embodiment of the invention, the polymeric compound is based on a non-crosslinked polystyrene homopolymer, of which at least one portion of the monomer units, and preferably more than 80% of the monomer units, correspond to one of the following formulas (I), (II) and (III):

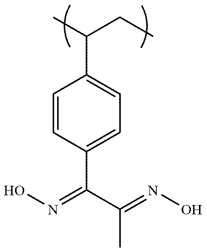

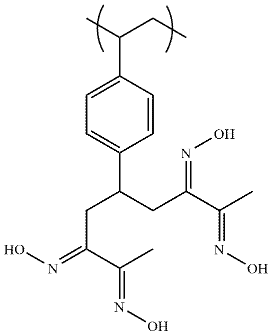

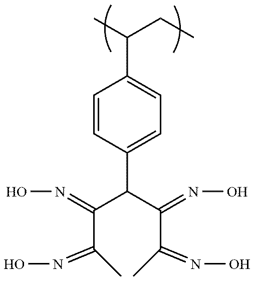

For capturing Ni(II), or even Co(II) ions, several synthesis strategies have been developed in order to functionalise a polymer or a commercial monomer, to obtain a low-cost polymeric compound and whose environmental impact is weak. These synthetic strategies are described by way of an example in the following. In these examples, polystyrene or styrene monomer, or one of the derivatives thereof, is selected.

A first strategy consists in starting from a commercial polystyrene, preferably non-crosslinked polystyrene. A glyoxime unit is introduced on at least one portion of the polystyrene monomer units, as illustrated in the reaction below. The different synthesis steps could be optimised to reach an overall efficiency of 85%, from commercial polystyrene. The characterisation of the intermediates and the obtained polymeric compound has been performed by infrared techniques (IR) and by nuclear magnetic resonance (NMR). A Ni(II) ion capture efficiency of 70% has been measured. This first strategy has in particular the advantage of obtaining a low-cost polymeric compound.

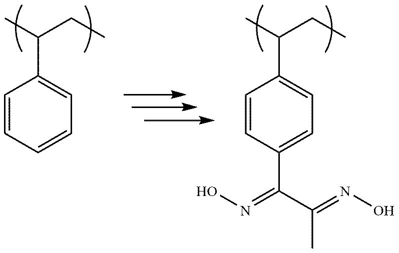

A second strategy consists in introducing two glyoxime units per polystyrene monomer unit, in order to improve the Ni(II) ion capture efficiency. For this, it is preferably possible to start from a poly(p-chloromethylstyrene), as illustrated by the reaction below.

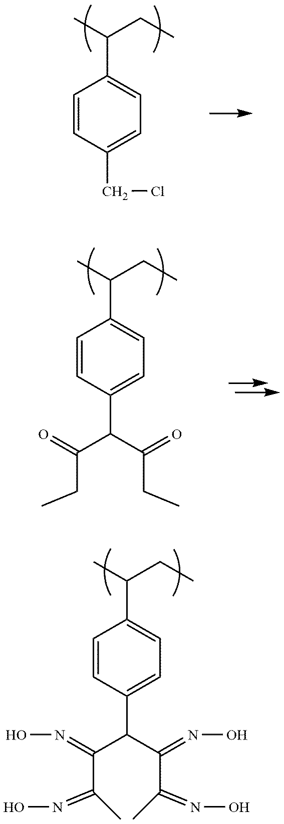

An example of synthesis of a polymeric compound according to a particular embodiment is now described in detail. According to this example, the polymeric compound is based on a polystyrene obtained by radical polymerisation, with a molecular weight comprised between 2000 and 5000 g/mol. The styrenic monomer units are functionalised by a ligand comprising a methylglyoxime group, as illustrated by formula (I) above. This polymeric compound is designated by the name poly(styren-4-methylglyoxime), abbreviated PS4MG below.

The method was developed from functionalisation methods described in the state of the art in order in particular to obtain a functionalisation rate greater than 80%, and to increase the synthesis efficiencies. It should be noted that, in the following formulas and the chemical reactions, only the monomer units intended to be functionalised by the ligand are represented.

A first functionalisation step is carried out, consisting in functionalising at least one portion of the styrene monomer units with a group comprising a carbonyl function. The polymeric compound comprising the at least one portion of the functionalised monomer units is designated by the abbreviation PS-CO in the following. The reaction can be illustrated by the reaction below.

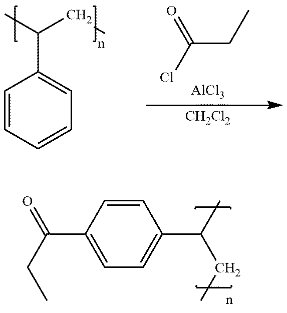

This reaction is carried out under argon atmosphere and follows a protocol adapted from M. Allegretti et al., J. Med. Chem., 2005, 48, 4312-4331. 9,6 mmol (10⁻³ mol) of polystyrene is added to 20 mL of distilled dichloromethane. The reaction medium thus formed is brought to 0° C. using an ice bath. 9.6 mmol of propionyl chloride is added dropwise to the reaction medium. 9.6 mmol of aluminium chloride, of formula AlCl₃, is then added little by little so as to avoid a rise in the temperature of the reaction medium. The reaction medium is stirred at 0° C. for 15 min after the end of the addition of AlCl₃. The reaction medium is then removed from the ice bath and left under stirring until the temperature of the reaction medium is at ambient temperature. The reaction medium is then refluxed for three hours and then filtered. The solid obtained by filtration is dissolved in acetone, then precipitated in methanol, these two steps being repeated twice. A yellowish powder is obtained with an efficiency of 83%. By nuclear magnetic resonance spectroscopy analysis of the ¹H, hydrogen nucleus, abbreviated ¹H- NMR in the following, a functionalisation rate of 87.5% of the PS-CO was measured.

A second PS-CO functionalisation step is then carried out, which can be illustrated by the reaction illustrated below. The polymeric compound comprising the functionalised monomer units at the end of this second step is designated in the following by the abbreviation PS—CO—NOH.

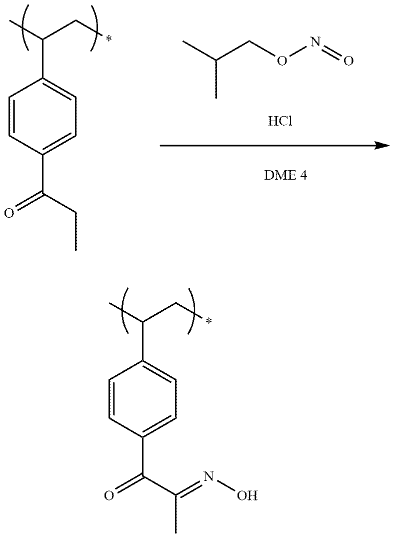

This reaction follows a protocol adapted from Org. Synth. 1936, 16, 44, DOI: 10.15227/orgsyn.016.0044. 6 mmol of PS-CO is added into 50 mL of distilled dimethoxyethane (abbreviated DME d). A bubbling of hydrogen chloride, of formula HCl, in the reaction medium carried out by performing a dropwise addition of sulfuric acid, of formula H₂SO₄, to sodium chloride, of formula NaCl. The reaction medium is stirred. After five minutes of stirring, 6 mmol of isoamyl nitrite is added by very slowly drip, [so as to avoid a heating of the reaction medium. The HCl bubbling is left for four hours during which the mixture is left under stirring. The reaction medium is then precipitated in a very large volume of water. The obtained solid is filtered then washed with water until the water resulting from the washing has a neutral pH. The solid is then dried to remove the water. The solid is then washed in methanol and rinsed with ether. A white powder is obtained with an efficiency of 74%. The functionalisation of PS—CO to PS—CO—NOH was verified by ¹H-NMR spectroscopy.

A third step of functionalisation of the PS—CO—NOH is then carried out in order to obtain the PS4MG. This step can be illustrated by the following reaction.

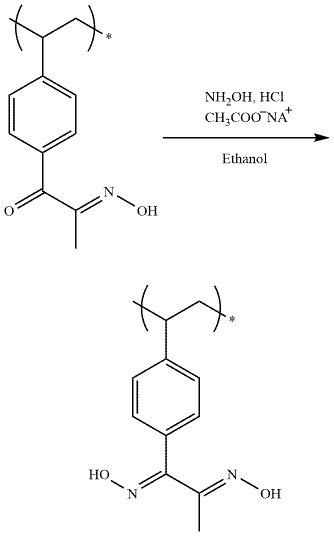

This reaction is carried out under argon atmosphere and follows a protocol adapted from A. Kilic et al, Inorganica Chimica Acta, 2013, 394, 635-644. 5 mmol of hydroxylamine is added into a balloon containing 20 ml of ethanol. 5 mmol of sodium acetate is then added. Once the reagents are solubilised in the reaction medium, 5 mmol of PS—CO—NOH is introduced in the reaction medium. The reaction is left under reflux and stirring for four hours, at about 80° C. The medium is left under stirring until the temperature of the reaction medium is at ambient temperature. The pH of the reaction medium is then reduced to a pH=3 by addition of concentrated soda (10 g.L⁻¹). The obtained solid is filtered then washed with water until the water from washing has a neutral pH. The solid is then dried to remove water. The solid is then washed in methanol then rinsed with ether. The functionalisation of the PS—CO—NOH in PS4MG has been verified by spectroscopy ¹H- NMR.

### 2) Description of a Cartridge According to One Embodiment

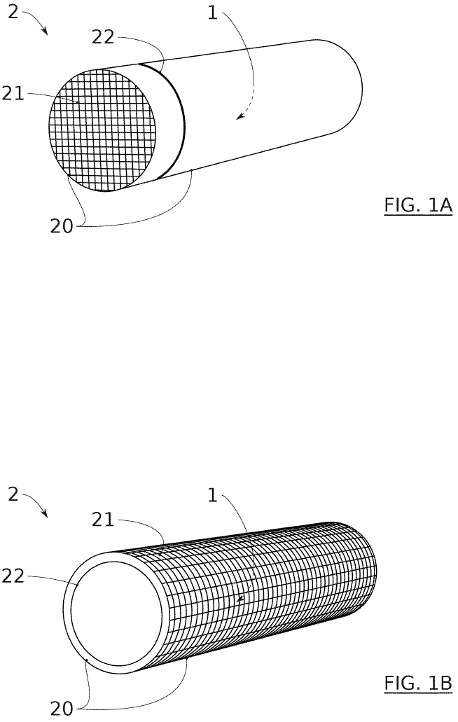

The polymeric compound 1 according to the first aspect of the invention can be contained in a cartridge 2, according to a second aspect of the invention. According to one example, this cartridge is described with reference to FIGS. 1A and 1B. The cartridge 2 is configured to contain the polymeric compound 1. The cartridge can thus be placed in a solution, such as an electrolysis bath or an effluent resulting from an electrochemical method, in order to carry out the capture of the Ni(II) ions by the polymeric compound 1. When the polymeric compound 1 reaches its limit ability of capturing Ni(II) ions, the cartridge can be removed from the bath, and can be replaced by a new cartridge.

The cartridge can be of a plurality of shapes, rigid or not. For example, the cartridge can be a non-rigid bag containing the polymeric compound. Preferably, the cartridge is rigid and cylindrical in shape. At least one wall 20 of the cartridge 2 comprises openings 21 configured so as to be able to allow a fluid to circulate on either side of the wall, while maintaining the polymeric compound 1 inside the cartridge 2. For example, at least one wall 20 of the cartridge 2 can be carried out from a grid or a porous material, the dimensions of which allow the circulation of the fluid while not allowing the polymeric compound to pass. The cartridge 2 can preferably be carried out from a material resistant to the operating conditions of the chemical methods, and in particular electrochemical methods. For example, the cartridge 2 is made of polyethylene, or of polypropylene.

Moreover, the cartridge 2 can comprise several sub-elements linked by a junction 22. The cartridge 2 can thus be disassembled so as to replace the polymeric compound 1. Thus, when the polymeric compound 1 reaches its limit ability of capturing Ni(II) ions, the polymeric compound 1 can be renewed in the cartridge 2. For example, the junction 22 can allow unscrewing or unclipping two sub-elements of the cartridge 2.

The dimensions of the cartridge 2, as well as the amount of polymeric compound 1 in the cartridge 2 can perhaps be adapted depending on the size of the device in which the cartridge is intended to be used. It is understood that these parameters can in particular be adapted depending on the volumes of the solutions to be treated. Also, a plurality of cartridges can, in addition or alternatively, be implemented in the same tank.

### 3) Description of a Device for Capturing Ni(II) Ion According to One Embodiment

The polymeric compound 1 according to the first aspect of the invention can be comprised in a device 3 for capturing Ni(II) ions, according to a third aspect of the invention. The device 3 further comprises a tank 30 which is clean and intended to contain a solution 31. The solution 31 is likely to comprise Ni(II) ions. The solution 31 may indeed comprise Ni(II) ions, for example the solution 31 is an effluent from a chemical or electrochemical method involving Ni(II) ions. The solution 31 may initially be free of Ni(II) ions, the Ni(II) ions being able to be released in solution during a chemical or electrochemical treatment, for example during the implementation of a treatment by electrogalvanisation. More particularly, the Ni(II) ions can be derived from the materials implemented in the device 3.

Since the Ni(II) ions can be captured by the polymeric compound 1, the materials implemented in the device 3 can comprise nickel, or even a higher nickel content. The impact on the environment of the Ni(II) ions in the solution 31 is therefore minimised, or even eliminated. Furthermore, the presence of nickel in the materials implemented by the device 3 allows increasing the service life of the device 3, and reducing its cost. The device may in particular comprise stainless steel materials, based on nickel.

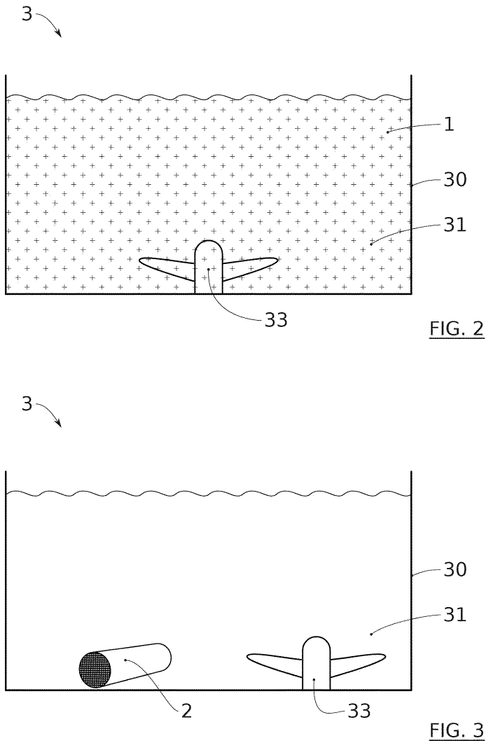

The device 3, according to particular embodiments, can be illustrated by FIGS. 2 to 4. According to the example illustrated in FIG. 2, the polymeric compound 1 can be free in the solution 31, contained in the tank 30. The device 3 can further comprise a stirrer 33, configured so as to homogenise the solution 31. Thus, the polymeric compound can be distributed throughout the solution 31.

According to the example illustrated in FIG. 3, the polymeric compound 1 can be contained in at least one cartridge 2 according to the second aspect of the invention, disposed in the solution 31. The use of a cartridge allows maintaining the polymeric compound 1 at a defined location of the solution 31. The device 3 can further comprise a stirrer 33, configured so as to homogenise the solution 31. Thus, the solution 31 can be mixed so as to promote the circulation of the solution through the cartridge 2 so that the polymeric compound 1 captures the Ni(II) ions carried by the flows passing through the cartridge 2.

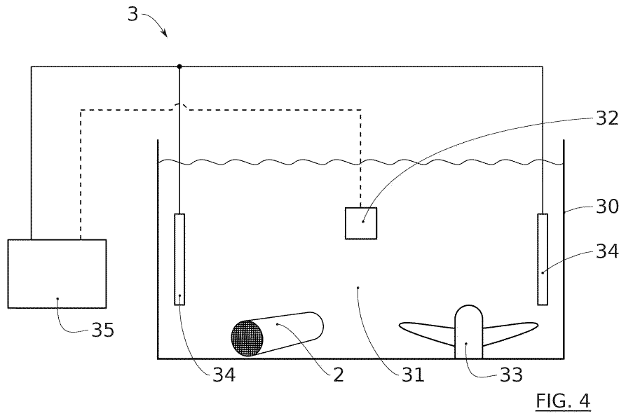

The device 3 may further comprise other elements, in order for example to implement an electrochemical method. According to the example illustrated in FIG. 4, the device 3 can comprise electrodes 34 connected to a current source 35. The device 3 can comprise a material 32, possibly connected to current source 35. For example, the device 3 can be used during the implementation of an electrogalvanising method. According to this example, the electrodes 34 act as anodes. The electrodes 34 may comprise metal zinc. Alternatively, the electrodes 34 may be free of zinc and Zn(II) ions are comprised in the solution 31. The material 32 may be connected to the current source 35 directly or via other materials or other elements, and acts as a cathode.

### 4) Description of a Method for Capturing Ni(II) Ion According to One Embodiment

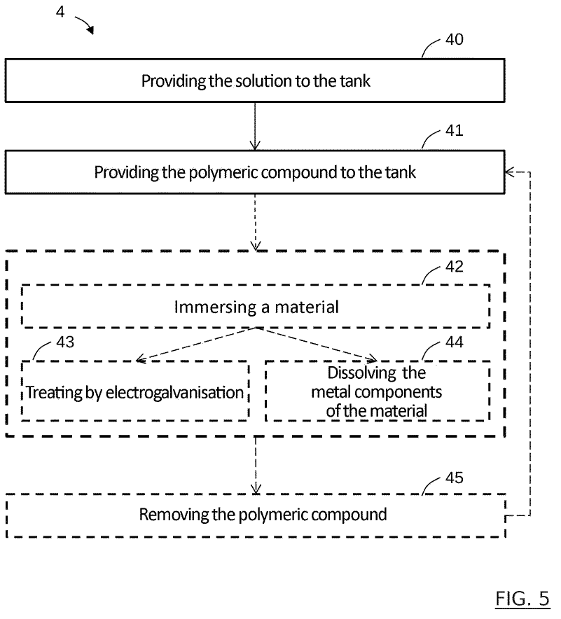

The polymeric compound 1 according to the first aspect of the invention can be used in a method 4 for capturing Ni(II) ions, according to a fourth aspect of the invention. The method 4 according to one embodiment is described in FIG. 5, where variants of the method are indicated by parallel paths and optional steps are indicated in dotted lines.

The method 4 comprises a step 40 of providing, in a tank 30, a solution 31 likely to comprise Ni(II) ions. In a second step, the polymeric compound 1 is provided in the tank 30. It can be provided that the relative order of these two steps can be reversed.

As previously stated, the solution 31 may comprise Ni(II) ions, for example, the solution 31 comes from an electrochemical treatment method, or a solution which is capable of implementing chemical or electrochemical treatment during which Ni(II) ions can be released. For example, the Ni(II) ions can derive from the tank 30. The Ni(II) ions being captured by the polymeric compound 1, the environmental impact of the solution is limited, even deleted, in particular concerning the toxicity of the nickel element. The capture of Ni(II) ions can thus be carried out at low concentrations of Ni(II) ions, more particularly at concentrations of less than 20 mg/ml. it should be noted that depending on the amount of polymeric compound added to the solution 31, solutions of concentrations greater than 20 mg/ml of Ni(II) ions can be treated. The method 4 can also comprise a step of mixing the solution 31 in order to promote the capture of Ni(II) ions.

The polymeric compound 1 can be provided 41 to the tank 30 so as to be free in the solution 31. The polymeric compound 1 can thus be removed 45 by filtering the solution 31. Consequently, the captured Ni(II) ions are removed from the solution 31. The polymeric compound 1 can be provided 41 to the tank 30 through at least one cartridge 2, according to the second aspect of the invention. The polymeric compound 1, as well as the captured Ni(II) ions, can thus be easily removed 45 by removing the cartridge 2 of the solution 31. A new cartridge 2, or even the same cartridge 2 comprising a renewed polymeric compound, can then be provided 41 in the tank 30.

The method 4 can comprise a step 42 of at least partially immersing a material 32, in the solution 31, in order to treat this material by a chemical or electrochemical method.

More particularly, the material 32 can include nickel-based metal components, or even the material 32 can comprise metal components based on a mixture of metals comprising nickel. The method can comprise a step 44 for dissolving at least one portion of this material, and more particularly at least one portion of the metal components thereof, for example for recycling purposes. During this dissolution, Ni(II) ions, even a plurality of metal ions including Ni(II) ions, are released in solution. Ni(II) ions selectively captured by the polymeric compound, can thus be removed from the solution 31, and recovered for example for their valuation. Alternatively, the capture and removal of the Ni(II) ions can allow separating the Ni(II) ions from other metal ions of similar chemical properties. These metal ions, not captured by the polymeric compound 1, can then be recovered for their valorisation. Thus, the method 4 can allow avoiding adding a plurality of reagents, or even avoiding a succession of stages, aimed at separating these ions from the Ni(II) ions. Consequently, the impact on the environment as well as the cost of recycling the material 32 can be minimised.

For example, the method 4 can be implemented for recycling metal battery components. These metal components comprise cobalt and nickel. These two metals have very similar chemical properties, it is difficult to separate them. By the method 4, cobalt and nickel can be dissolved 44 in their respective form of Co(II) and Ni(II) ions. According to this example, the selective capture of the Ni(II) ions by the polymeric compound 1 allows separating the Ni(II) ions from the Co(II) ions, for example for their respective valorisation.

Moreover, the method 4 can be implemented for the electrochemical treatment of the material 32 which is at least partially immersed in the solution 31. More particularly, the method 4 may comprise a step 43 of treating by electrogalvanisation the material 32. According to this example, the solution 31 is aqueous and comprises metal salts, for example zinc Zn²⁺ ions or in an equivalent manner Zn(II), sodium Na⁺, ions, and non-metal salts. The nature of the salts can depend on the considered application and the desired properties of the coating. The method 4 can involve a device 3, which can comprise at least one electrode 34 connected to a current source 35, acting as anode. The material 32 can act as cathode. The Zn(II) ions are therefore reduced on the material 32 so as to make a metal zinc deposition.

A wide variety of depositions can be obtained depending on the formulation and the electrogalvanisation conditions. In addition to the composition of the solution 31, the treatment by electrogalvanisation 43 can be performed according to different variants whose choice depends on the type of treated product. Three main families of treatment are in particular considered:
bulk treatment (known as “barrel treatment”) intended for small and medium-sized parts that are not affected by shocks;
the unit treatment (known as “attachment treatment” or “rack treatment dedicated to parts of larger dimensions, fragile or requiring a deposition appearance with the least possible defect;
continuous treatment (known as “running treatment” or “high-speed treatment”) reserved mainly for sheet metals, tubes or wires.

By way of example, an application of PS4MG in an electrogalvanising method is detailed, and compared to alternative strategies used to delay the induction period. As a reminder, these strategies consist in using surfactants or inhibitors of the hydrogen production reaction such as potassium sulphate.

According to this example, electrogalvanisation is carried out at 1000 A/m² for 4 hours in a solution 31 of 50 g/L of Zn(II) and 200 g/L of sulfuric acid. 5 mg/L of nickel sulphate are added to the solution 31. Without the addition of a surfactant or potassium sulphate, zinc deposition is impossible beyond three hours. The induction period is therefore three hours under these conditions.

With an addition of potassium sulphate at 10 g/L or surfactant at 40 mg/L, the faradic efficiency is estimated between 80 and 85% after three hours of deposition. Adding these additives allows obtaining an induction period of four hours. For a nickel sulphate concentration of 20 mg/L, however, zinc deposition is impossible. The combination of potassium sulphate and surfactant is also ineffective in countering the dissolution of the deposited zinc, after the induction period. Potassium sulphate or a surfactant could therefore be qualified as induction retardant additives because beyond a certain concentration of nickel sulphate or a certain deposition time, they are no longer effective.

In a solution 31, comprising 50 g/L of Zn(II), 200 g/L of sulfuric acid, and 20 mg/L of nickel sulphate, without potassium sulphate nor surfactant, the PS4MG is introduced in large excess. Without the polymeric compound, in 4 hours of deposition at 1000 A/m², the induction should be reached and no deposition would be possible.

With the addition of the polymeric compound in solution 31, after 4 h, there was no induction and the faradic efficiency is 84%. The capture of Ni(II) ions by the PS4MG allows, under these conditions, neutralising the induction phenomenon. Although Ni(II) and Zn(II) ions have similar chemical properties, PS4MG captures Ni(II) ions, but reacts very little, if at all, with Zn(II) ions. In addition, this example has allowed demonstrating the stability of PS4MG in an acid medium. In this example, 1 kg of PS4MG can capture 30 to 50 g of Ni(II) ions.

The complexation of Ni(II) ions by the polymeric compound, according to a particular embodiment, has been verified from a solution of Ni(II) ions, formed by dissolving nickel(II) sulphate and/or nickel (II) nitrate at a concentration of 0.1 mol.L⁻¹. The previously described polymer PS4MG is added to the solution in excess relative to the concentration of Ni(II) ions. The monitoring of the complexation of Ni(II) ions by PS4MG is performed by UV-visible spectrophotometry, at a wavelength of 390 nm. The complexation is observed by the progressive colouring of the PS4MG, going from white to ochre, associated with a strong decrease in the absorbance of the solution at 390 nm. The measurement of this decrease in absorbance allows determining that more than 90% of the Ni(II) ions in solution have been captured by the PS4MG.

The invention is not limited to the previously described embodiments and extends to all the embodiments covered by the claims.

### LIST OF REFERENCES

1 Polymeric compound
2 Cartridge
20 Wall
21 Opening
22 Junction
3 Device
30 Tank
31 Solution
32 Material
33 Stirrer
34 Electrode
35 Current source
4 Method
40 Providing the solution
41 Providing the polymeric compound
42 Immersing the material
43 Treating by electrogalvanisation
44 Dissolving
45 Removing the polymeric compound

1. A polymeric compound based on a polymer selected from styrenic polymers and chloropolymers, wherein the polymer comprises monomer units capable of being functionalised by a ligand, at least one portion of said monomer units of the polymer being functionalised by said ligand, said ligand comprising at least one chemical group selected from the glyoxime groups of semi-structural formula HON=CRCR'=NOH, where R and R' are independently selected from a covalent bond between two carbon atoms, H, CH₃, an alkyl group, and an alkylene group.

2. The polymeric compound according to claim 1, wherein the said at least one chemical group is a methylglyoxime group of semi-structural formula HON=CRCR"=NOH, where R" represents CH₃.

3. The polymeric compound according to claim 1, wherein the weight average molecular weight of the polymer free of the ligand is comprised between 2000 and 10000 g/mol.

4. The polymeric compound according to claim 1, wherein the functionalisation rate by the ligand of said at least one portion of the monomer units of the polymer is greater than 80%.

5. The polymeric compound according to claim 1, wherein the monomer units capable of being functionalised by said ligand are selected from styrene units and the derivatives thereof, 4-chloromethyl-styrene units and vinyl chloride units.

6. The polymeric compound according to claim 5, wherein, said at least one chemical group being a methylglyoxime group of semi-structural formula HON=CRCR"=NOH, where R" represents CH₃, the at least one portion of the polymer monomers units functionalised by said ligand correspond to one of the following formulas (I), (II) and (III): 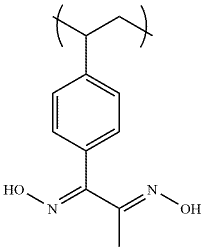 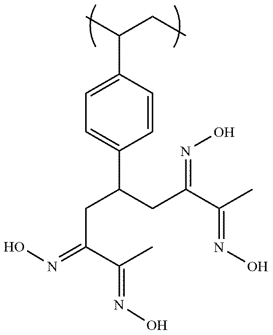 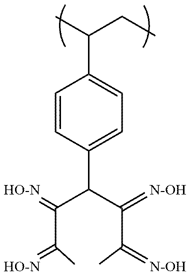
.

7. A cartridge configured to contain the polymeric compound according to claim 1, wherein at least one wall comprises openings configured so as to allow a fluid to circulate on either side of said at least one wall, while maintaining the polymeric compound inside the cartridge.

8. A device for capturing Ni(II) ions in solution comprising the polymeric compound according to claim 1, and a clean tank and intended to contain a solution said solution being likely to comprise Ni(II) ions.

9. The device according to claim 8, wherein the polymeric compound is contained in a cartridge at least one wall of said cartridge comprising openings configured so as to allow the solution to circulate on either side of said at least one wall, while maintaining the polymeric compound inside the cartridge.

10. A method for capturing Ni(II) ions in solution comprising the following steps:
providing in a tank, a solution likely to comprise Ni(II) ions;
providing, in the tank, the polymeric compound according to claim 1.

11. The method according to claim 10, wherein, in the step of providing the polymeric compound the polymeric compound is contained in at least one cartridge at least one wall of said cartridge comprising openings configured so as to allow the solution to circulate on either side of said at least one wall, while maintaining the polymeric compound inside the cartridge.

12. The method according to claim 10, further comprising a step of at least partially immersing a material in the solution, and a step of treating by electrogalvanisation an immersed portion of the material, said solution comprising chemical species capable of implementing the treatment by electrogalvanisation.

13. The method according to claim 10, the method further comprising a step of at least partially immersing a material in the solution, the material comprising nickel-based metal components, and a step for dissolving at least one portion of the metal components of the material.
